(19) United States
(12) Patent Application Publication
(10) Pub. No.: US 2011/0246339 A1
(43) Pub. Date: Oct. 6, 2011

(54) Generating Financial Report Information

(75) Inventors: Michelle M. Jablonski, Yardley, PA (US); Brian Dietrich, Yardley, PA (US); John Scully, Hamilton Square, NJ (US); Annabelle Chen, Cranbury, NJ (US)

(73) Assignee: BANK OF AMERICA CORPORATION, Charlotte, NC (US)

(21) Appl. No.: 12/750,941

(22) Filed: Mar. 31, 2010

(51) Int. Cl. G06Q 40/00; G06Q 10/00

(52) U.S. Cl. 705/30

(57) ABSTRACT

In some embodiments, a method for generating financial report information comprises receiving customer information associated with an account portfolio from a customer information database. The account portfolio comprises one or more customer accounts. A change in value for each of the one or more customer accounts is determined over a defined period. The one or more transactions represent asset activity associated with one or more customer accounts. One or more account rates of return are determined for each of the one or more customer accounts over the defined period. A portfolio rate of return is determined for the customer's account portfolio over the defined period. The portfolio rate of return and the one or more account rates of return are communicated to a reporting system.

### TECHNICAL FIELD

The present disclosure relates generally to reports and more specifically to generating financial report information.

### BACKGROUND

Reports present content to a specified audience. For example, financial reports may be used to display information regarding a customer's financial activities with a financial institution. Financial activities may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio. A financial institution may include any individual, business, or organization that engages in financial activities.

### SUMMARY

In some embodiments, a method for generating financial report information comprises receiving customer information associated with an account portfolio from a customer information database. The account portfolio comprises one or more customer accounts. A change in value for each of the one or more customer accounts is determined over a defined period. The one or more transactions represent asset activity associated with one or more customer accounts. One or more account rates of return are determined for each of the one or more customer accounts over the defined period. A portfolio rate of return is determined for the customer's account portfolio over the defined period. The portfolio rate of return and the one or more account rates of return are communicated to a reporting system.

Certain embodiments of the invention may provide one or more technical advantages. A technical advantage of one embodiment may include the capability to gather information from a variety of sources regarding a customer's activities with a financial institution. A technical advantage of one embodiment may also include the capability to quickly and efficiently process and generate financial report information. A technical advantage of one embodiment may also include the ability to generate financial report information, such as rates of return, at the end of each business day. A technical advantage of one embodiment may also include the capability to standardize financial report information across multiple business lines and provide information on items such as balances, holdings, portfolio analysis, and performance details.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following description taken in conjunction with the accompanying drawings, in which:

FIG. 1 shows a financial information generation system according to one embodiment;

FIG. 2 shows one embodiment of a computer system; and

FIG. 3 shows a method for calculating rates of return according to one embodiment.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

A financial institution may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio. Financial information may include, but is not limited to, current data, historical data, and effective-dated data. Financial information may also include data other than a customer's data, such as market data, fund data, and any other suitable data.

Financial institutions may engage in such diverse financial activities through one or multiple lines of business. Teachings of certain embodiments recognize the capability to gather information regarding a customer's activities with a financial institution from one or multiple lines of business.

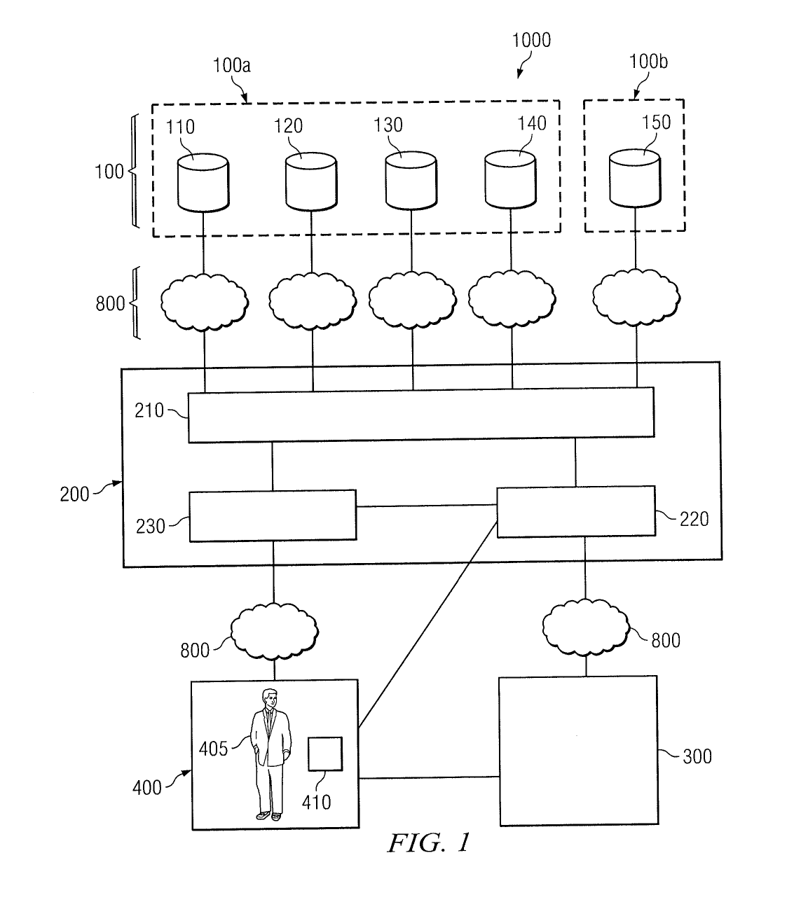

FIG. 1 shows a financial information generation system 1000 according to one embodiment. In operation, system 1000 generates financial information from financial datastores 100. In this example, system 1000 features financial datastores 100, a performance measurement system 200, a reporting system 300, and a quality control system 400.

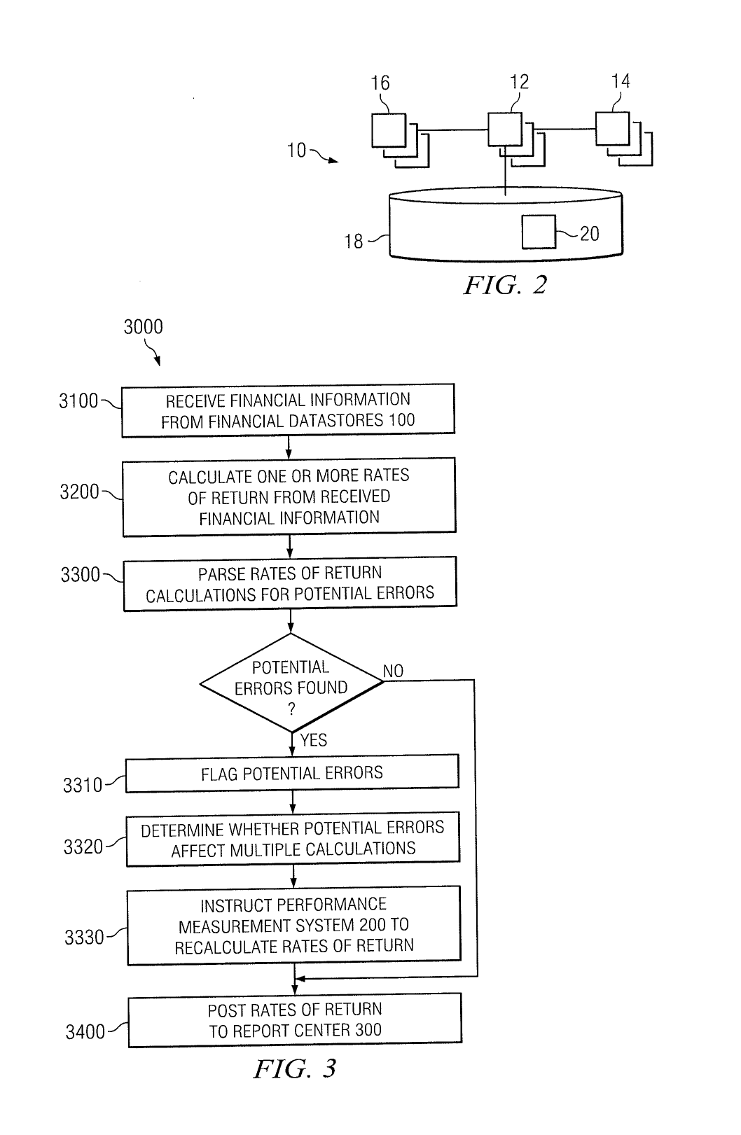

Financial datastores 100 provide financial information. One example of a financial datastore 100 may include the memory 18 of FIG. 2. In the illustrated example, financial datastores 100 include a customer information datastore 110, a transaction information datastore 120, a securities datastore 130, an accounts datastore 140, and a managed accounts datastore 150. In various embodiments, customer information datastore 110, transaction information datastore 120, securities datastore 130, accounts datastore 140, and managed accounts datastore 150 may be stored separately or together on one or more memories 18.

In some embodiments, financial datastores 100 provide information regarding one or more customer's activities with one or more financial institutions. For example, in the illustrated embodiment, a first financial institution 100a provides financial information through financial datastores 110-140, and a second financial institution 100b provides financial information through managed accounts datastore 150.

Customer information datastore 110 provides information regarding one or more customers of financial institution 100a. Such information may include, but is not limited to, information identifying the one or more customers (e.g., name or customer number); accounts of the one or more customers (e.g., account number); and transactions requested by the one or more customers. For example, in one embodiment, customer information datastore 110 provides information regarding a customer's account portfolio, which includes one or more accounts. Accounts identified in customer information datastore 110 are not necessarily limited to accounts held with first financial institution 110a. Rather, customer information datastore 110 may identify customer accounts with any suitable financial institution. In one example embodiment, customer information datastore 110 identifies customer accounts in account datastore 140.

Transaction information datastore 120 provides information regarding one or more transactions. Transactions may represent assets movement into, out of, or within one or more customer accounts. An asset may include any economic resource, including, but not limited to, cash and securities. Examples of transaction information may include, but are not limited to, information regarding deposits, withdrawals, orders to buy and sell securities, and money transfers between accounts.

Securities datastore 130 provides information regarding one or more investment securities. An investment security is a fungible, negotiable instrument representing financial value. Investment securities may include, but are not limited to, debt securities, such as banknotes, bonds, and debentures; equity securities, such as common stock; and derivative contracts, such as forwards, futures, options, and swaps. Examples of securities information may include, but are not limited to, identification of securities, prices of securities, and market information.

Account datastore 140 provides information regarding one or more customer accounts. In one example embodiment, account datastore 140 provides additional information regarding customer accounts identified by customer information datastore 110. Examples of account information includes, but is not limited to, account numbers, balances, limits, and transaction histories. As one example, a transaction history stored in account datastore 140 may identify transactions recorded in transaction information datastore 140.

Managed accounts datastore 150 provides information regarding one or more managed accounts. A managed account may include any account managed by an advisor not otherwise associated with first financial institution 100a. For example, in some embodiments, a customer may hire an outside advisor not associated with first financial institution 100a for additional expertise and wealth planning strategies (e.g., an outside advisor specializing in conservative investment strategies, etc.).

In one exemplary embodiment, a financial advisor with first financial institution 100a arranges for a customer of first financial institution 100a to enroll in a financial product offered by second financial institution 100b. In this example, managed accounts datastore 150 may provide any relevant information regarding the customer's managed account, including any information that would otherwise be stored in financial datastores 110-140.

In some embodiments, managed accounts datastore 150 is associated with and maintained by second financial institution 100b. In other embodiments, second financial institution 100b uploads information to managed accounts datastore 150 associated with first financial institution 100a.

In the illustrated embodiment, performance measurement system 200 includes one or more information retrieval modules 210, one or more performance measurement modules 220, and one or more correction modules 230. One example of measurement system 200 includes computer system 10 of FIG. 2.

Example information retrieval modules 210 include any devices and/or logic suitable to receive and/or extract information from financial datastores 100. In some embodiments, information retrieval modules 210 retrieve information according to instructions from performance measurement modules 220. One example instruction might include an instruction to retrieve information regarding a specified customer, account, and/or transaction.

In some embodiments, information retrieval modules 210 autonomously gather information based on information received. For example, if information retrieval modules 210 receive transaction information from transaction information datastore 120 regarding moving money into a customer account, information retrieval modules 210 may retrieve information regarding the affected customer account from account datastore 140.

In some embodiments, information retrieval modules 210 gather information based on periodically-performed routines. For example, in one embodiment, information retrieval modules gather transaction information daily for daily rate-of-return calculations.

Example performance measurement modules 220 include any device and/or logic suitable to receive information from information retrieval modules 220 and generate financial report information. Financial report information includes any financial information suitable for inclusion in a financial report.

In some embodiments, performance measurement modules 220 receive information from information retrieval modules 220 in a form already suitable for inclusion in a financial report. In other embodiments, performance measurement modules 200 perform some calculation or data conditioning.

For example, in one embodiment, performance measurement modules 220 calculates a rate of return based on the received information. Rate of return is the ratio of money gained or lost, whether realized or unrealized, on an investment relative to the amount of money invested.

In one illustrative example, performance measurement modules 220 receives information regarding a customer's portfolio (e.g., account numbers, balances, transaction histories, etc.), including: a customer checking account, a financial product, a transaction transferring money from the customer checking account to the financial product, and/or performance information regarding the financial product. In this example, performance measurement modules 220 may calculate the rate of return on the customer's portfolio by evaluating performance of the checking account (e.g., interest earned on the checking account) and the financial product. In some embodiments, performance measurement modules 220 recognizes that the transfer between the customer checking account and the financial product is internal to the customer's portfolio and therefore does not change an overall value of the customer's portfolio. In this example, performance measurement modules 220 would recognize interest and dividends received by the customer's checking account and the financial product, respectively, because such transfers are not internal to the customer's portfolio.

In these examples, performance measurement modules 220 may calculate a rate of return over any suitable defined period and/or over any suitable accounts, assets, and/or portfolios. Suitable defined periods may include, but are not limited to, specified business days, weeks, months, quarters, years, or any period defined between two dates. For example, teachings of certain embodiments recognize the capability to generate financial report information between any two dates (e.g., Dec. 7, 2009, to Feb. 26, 2010), even if the two defined dates do not begin or end during a conventional reporting period, such as a month or quarter.

In some embodiments, performance measurement modules 220 generate financial report information, such as rates of return, at the end of each business day. For some companies, this may require processing of twenty million transactions and eighty million positions daily for eight million domestic and international accounts, which may also include multi-currency calculations. Teachings of certain embodiments recognize the capabilities to quickly and efficiently process and generate financial report information based on the large volume of data.

In some embodiments, performance measurement modules 220 categorize transactions based on patterns in the transaction information data. For example, a transaction may be characterized according to a transaction code, an explanation code, and a description field. In this example, performance measurement modules 220 parses these fields to search for specific information. For example, performance measurement modules 220 may search for a specific transaction according to a transaction code or for all transactions of a specified group according to an explanation code.

In some embodiments, multiple performance measurement modules 220 (or alternatively, subroutines or sub-measurement modules) may operate concurrently via parallel processing. For example, in one embodiment, performance measurement modules 220 split incoming financial data into smaller segments and place the segments into parallel batch processing files. In this example, data stored in financial datastores 100 may be organized from a key perspective so as to minimize competition for data, thus helping prevent the financial datastores 100 from crashing. For example, financial datastores 100 may be organized such that multiple performance measurement modules 220 operating concurrently via parallel processing will access different parts of financial datastores 100 in order to prevent congestion.

Example correction modules 230 include any devices and/or logic suitable to request and/or implement changes or corrections to financial report information generated by performance measurement modules 200. For example, in one embodiment, correction modules 230 request and/or implement changes or corrections to financial report information based on directives received from quality control system 400.

In the illustrated embodiment, reporting system 300 represents any suitable device or logic for receiving financial report information from performance measurement system 200. One example of reporting system 300 includes computer system 10 of FIG. 2. Another example of reporting system 300 may include a report generating system, such as the report generation system 1000 of U.S. Patent Application No. ______, titled “Generating Financial Reports,” filed Mar. 31, 2010, [[Attorney Docket No. 015444.0544, PMN 4020US1]], which is hereby incorporated by reference in its entirety.

In the illustrated embodiment, quality control system 400 includes one or more users 405 and one or more quality control modules 410. One example of quality control module 410 includes computer system 10 of FIG. 2. Users 405 may include any individual, group of individuals, entity, machine, and/or mechanism that interacts with quality control module 410. Examples of users 405 include, but are not limited to, quality control personnel, customer service representatives, managers, executives, accountants, engineers, technicians, contractors, agents, and/or employees.

Quality control module 410 represents any suitable device or logic for checking quality of financial report information produced by performance measurement system 200. In one example embodiment, quality control system 400 parses the financial report information for potential errors. In this example, quality control module 410 flags the financial report information if it detects a potential error and then reports the potential error to correction modules 230. Correction modules 230 may then issue corrections and request recalculation of the flagged financial report information.

In one embodiment, quality control module 410 creates exceptions based on business rules and underlying data during a quality assurance load process. An exception may have a status code indicating whether the exception is open, closed, or under review. Quality control module 410 may close exceptions through a quality assurance corrections process or through an auto-close process. The quality assurance corrections process provides a front-end graphic user interface tool to one or more users 405. The auto-close process programmatically opens and closes exceptions based on the current values of the underlying data.

Quality control system 400 may be configured to detect a variety of potential errors. As one example, sometimes financial information received from financial datastores 100 may be incomplete. For example, a security from securities datastore 130 may be missing opening position data on a particular date, which could cause performance measurement modules 220 to generate an indefinite rate of return. In this example, quality control system 400 may receive the missing opening position data from users 405 or through an automatic process and then instruct performance measurement system 200 to generate new rate of return information.

As another example, quality control system 400 may parse financial report information for unusual results. In one example, quality control module 410 may flag any financial report information that suggests a negative value for a security. In another example, quality control module 410 may flag financial report information that suggests results outside of normal performance (e.g., 200% profit over one business day). In another example, quality control module 410 may compare financial report information to market performance (e.g., flagging 50% reported profit on stock in Company A if the market value of stock in Company A lost 25% over the same time period).

As yet another example, quality control system 400 may compare financial report information with other financial information provided by financial datastores 100. In one example, generated financial report information includes that a customer owns 100 shares of stock in Company B, but financial datastores 100 have no record of a buy order of Company B stock for the customer. In this example, quality control module 410 may reconcile the financial report information with information provided by financial datastores 100 to determine whether the 100 shares of stock in Company B belong to the customer.

In some examples, potential errors affect more than one piece of financial report information. For example, a missing price position for one security may cause rate of return calculation errors for multiple accounts and multiple customers. In this example, quality control module 410 may batch the potential errors and issue a correction for the batch of potential errors. In one example, quality control module 410 would identify the missing price position and instruct performance measurement system 200 to generate new rate of return information for the batch of potential errors.

In another example, one potential error may result in cascading errors. A cascading error may include any error in which fixing the error creates a new error. Teachings of certain embodiments recognize the capability to implement cascading corrections in response to cascading errors.

By way of illustration, one non-limiting example of a cascading error may include an incorrect closing position price of a security. Correcting the closing position price of the security may change a rate of return calculated for that day. However, changing the closing position price of a security for day one may necessitate changing the opening position price of the security for the following day two, which would change the rate of return calculated for day two as well. Thus, correcting the closing position price and rate of return on day one requires correcting the opening position price and rate of return on day two.

Another non-limiting example of a cascading error may include recording an incorrect sale price of a security. For example, a customer may sell a security for $100 on February 16, but the sale price is recorded in error at $1,000. This error may not be detected immediately. In this example, the error may be detected on April 22. Thus, on April 22, the sale price is changed to $100, and the rate of return for February 16 is recalculated. However, changing the rate of return for February 16 may also change the rate of return for several other time periods, including but not limited to: the month of February; year-to-date through February; year-to-date through March; first quarter of the year; and year-to-date on April 22. Accordingly, teachings of certain embodiments recognize the capability to issue cascading corrections to new errors created or identified when correcting known errors.

In the illustrated embodiments, various components of system 1000 communicate across one or more networks 800. System 1000 may include one or more networks 800. For example, FIG. 1 shows multiple networks 800. However, teachings of certain embodiments recognize that more or fewer networks 800 may be used. Further, teachings of certain embodiments also recognize that communication over network 800 is one example of a mechanism for communicating between parties, and any suitable mechanism may be used.

Network 800 may represent any number and combination of wireline and/or wireless networks suitable for data transmission. Network 800 may, for example, communicate internet protocol packets, frame relay frames, asynchronous transfer mode cells, and/or other suitable information between network addresses. Network 800 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding.

In operation, according to one embodiment, system 1000 receives, processes, and verifies financial information. For example, in one embodiment, information retrieval modules 210 receive and/or extract financial information from financial datastores 100 and deliver financial information to performance measurement modules 220. Performance measurement module 200 generates financial report information from the received financial information and delivers the financial report information to reporting system 300. Quality control system 400 facilitated the process of checking the financial report information for potential errors and initiates mechanisms for correcting financial report information.

FIG. 2 shows one embodiment of a computer system 10. Computer system 10 may include processors 12, input/output devices 14, communications links 16, and memory 18. In other embodiments, computer system 10 may include more, less, or other components.

Computer system 10 may be operable to perform one or more operations of various embodiments. Although the embodiment shown provides one example of computer system that may be used with other embodiments, such other embodiments may additionally utilize computers other than computer system 10. Additionally, embodiments may also employ multiple computer systems 10 or other computers networked together in one or more public and/or private computer networks, such as one or more networks 800.

Processors 12 represent devices operable to execute logic contained within a medium. Examples of processor 12 include one or more microprocessors, one or more applications, and/or other logic. Computer system 10 may include one or multiple processors 12.

Input/output devices 14 may include any device or interface operable to enable communication between computer system 10 and external components, including communication with a user or another system. Example input/output devices 14 may include, but are not limited to, a mouse, keyboard, display, and printer.

Network interfaces 16 are operable to facilitate communication between computer system 10 and another element of a network, such as other computer systems 10. Network interfaces 16 may connect to any number and combination of wireline and/or wireless networks suitable for data transmission, including transmission of communications. Network interfaces 16 may, for example, communicate audio and/or video signals, messages, internet protocol packets, frame relay frames, asynchronous transfer mode cells, and/or other suitable information between network addresses. Network interfaces 16 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 18 represents any suitable storage mechanism and may store any information for use by computer system 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 18 stores logic 20. Logic 20 facilitates operation of computer system 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by computer system 10. Example logic 20 may include any of the well-known OS2, UNIX, Mac-OS, Linux, Windows Operating Systems, any other mainframe operating system such as Multiple Virtual Storage, or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

FIG. 3 shows a method 3000 for generating financial report information according to one embodiment. This embodiment describes an example method of calculating rates of return. At step 3100, retrieval module 210 receives financial information from financial datastores 100. At step 3200, performance measurement module 220 calculates one or more rates of return from the received financial information.

At step 3300, quality control system 400 parses the calculated rates of return for potential errors and determines whether any potential errors exist. If quality control system 400 identifies potential errors, quality control system 400 flags the potential errors at step 3310. At step 3320, quality control system 400 determines whether the potential errors affect multiple calculations. For example, quality control system 400 may batch the potential errors and issue a correction for the batch of rates of returns.

At step 3330, quality control system 400 instructs performance measurement system 200 to recalculate the one or more rates of return. In some embodiments, step 3300 may include correcting cascading errors, as explained above. As one example, step 3300 may include calculating rates of returns for all affected defined periods (e.g., day, month, quarter, year-to-date, etc.). At step 3400, performance measurement system 200 communicates the calculated rates of return to report system 300.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Certain embodiments of the invention may provide one or more technical advantages. A technical advantage of one embodiment may include the capability to gather information from a variety of sources regarding a customer's activities with a financial institution. A technical advantage of one embodiment may also include the capability to quickly and efficiently process and generate financial report information. A technical advantage of one embodiment may also include the ability to generate financial report information, such as rates of return, at the end of each business day. A technical advantage of one embodiment may also include the capability to standardize financial report information across multiple business lines and provide information on items such as balances, holdings, portfolio analysis, and performance details.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §12 as it exists on the date of filing hereof unless the words “means for” or “step for” are explicitly used in the particular claim.

What is claimed is:

1. A method for generating financial report information, comprising:
receiving customer information associated with an account portfolio from a customer information database, the account portfolio comprising one or more customer accounts;
determining a change in value for each of the one or more customer accounts over a defined period;
determining one or more account rates of return for each of the one or more customer accounts over the defined period;
determining a portfolio rate of return for the account portfolio over the defined period; and
communicating the portfolio rate of return and the one or more account rates of return to a reporting system.

2. The method of claim 1, wherein the defined period is one business day.

3. The method of claim 2, wherein the one business day is a business day immediately preceding the calculating a rate of return for the account portfolio.

4. The method of claim 1, further comprising:
receiving transaction information associated with one or more transactions from a transaction information database, the one or more transactions representing asset activity associated with the one or more customer accounts; and
selecting from the one or more transactions one or more transactions that change a value of assets with the one or more customer accounts, wherein the determining one or more account rates of return comprises calculating the one or more account rates using the one or more transactions that change the value of assets within the one or more customer accounts.

5. The method of claim 1, further comprising communicating the calculation of the one or more account rates of return to a quality control system, wherein the quality control system:
determines whether the one or more account rates of return comprise one or more errors;
flags each of the one or more account rates of return as having an error; and
communicates the one or more to a correction module, the correction module operable to issue corrections and request recalculation of the flagged one or more account rates.

6. The method of claim 5, further comprising combining the errors if the errors affect a predetermined number of customer accounts, the quality correction module being further operable to correct the combined potential errors.

7. The method of claim 5, wherein:
at least one of the one or more customer accounts is associated with an investment security;
determining whether the one or more account rates of return comprise one or more errors comprises:
classifying the at least one of the one or more customer accounts according to a type of investment security of the investment security,
identifying opening and closing positions of the investment security at the beginning and end of the defined period,
determining a change in value of the investment security from the beginning to the end of the defined period,
comparing the change in value of the investment security to the calculated rates of return for the at least one of the one or more customer accounts, and
if the type of investment of the investment security is a type traded on a market, comparing a market performance of the investment security to the calculated rates of return for the at least one of the one or more customer accounts; and
flagging each of the one or more account rates of return as having an error comprises flagging the at least one of the one or more customer accounts if a difference between the calculated rates of return for the at least one of the one or more customer accounts and the change in value of the investment security exceeds a first predetermined limit or a difference between the calculated rates of return for the at least one of the one or more customer accounts and the market performance exceeds a second predetermined limit.

8. A system for generating financial report information, comprising:
a retrieval module operable to:
receive customer information associated with an account portfolio from a customer information database, the account portfolio comprising one or more customer accounts; and
a performance measurement module operable to:
determine a change in value for each of the one or more customer accounts over a defined period;
determine one or more account rates of return for each of the one or more customer accounts over the defined period;
determine a portfolio rate of return for the customer's account portfolio over the defined period; and
communicate the portfolio rate of return and the one or more account rates of return to a reporting system.

9. The system of claim 8, wherein the defined period is one business day.

10. The system of claim 9, wherein the one business day is a business day immediately preceding the calculating a rate of return for the account portfolio.

11. The system of claim 8, the performance measurement module further operable to:
receive transaction information associated with one or more transactions from a transaction information database, the one or more transactions representing asset activity associated with the one or more customer accounts; and
select from the one or more transactions one or more transactions that change a value of assets with the one or more customer accounts, wherein the determining one or more account rates of return comprises calculating the one or more account rates using the one or more transactions that change the value of assets within the one or more customer accounts.

12. The system of claim 8, further comprising a quality control system operable to:
determine whether the one or more account rates of return comprise one or more errors;
flag each of the one or more account rates of return as having an error; and
communicate the one or more to a correction module, the correction module operable to issue corrections and request recalculation of the flagged one or more account rates.

13. The system of claim 12, the quality control system being further operable to combine the errors if the errors affect a predetermined number of customer accounts, the quality correction module being further operable to correct the combined potential errors.

14. The system of claim 12, wherein:
at least one of the one or more customer accounts is associated with an investment security;
the quality control system being further operable to determine whether the one or more account rates of return comprise one or more errors by:
classifying the at least one of the one or more customer accounts according to a type of investment security of the investment security,
identifying opening and closing positions of the investment security at the beginning and end of the defined period,
determining a change in value of the investment security from the beginning to the end of the defined period,
comparing the change in value of the investment security to the calculated rates of return for the at least one of the one or more customer accounts, and
if the type of investment of the investment security is a type traded on a market, comparing a market performance of the investment security to the calculated rates of return for the at least one of the one or more customer accounts; and
the quality control system being further operable to flag each of the one or more account rates of return as having an error by flagging the at least one of the one or more customer accounts if a difference between the calculated rates of return for the at least one of the one or more customer accounts and the change in value of the investment security exceeds a first predetermined limit or a difference between the calculated rates of return for the at least one of the one or more customer accounts and the market performance exceeds a second predetermined limit

15. A non-transitory computer readable medium comprising logic for execution, the logic, when executed by a processor, operable to:
receive customer information associated with an account portfolio from a customer information database, the account portfolio comprising one or more customer accounts;
determine a change in value for each of the one or more customer accounts over a defined period;
determine one or more account rates of return for each of the one or more customer accounts over the defined period;
determine a portfolio rate of return for the customer's account portfolio over the defined period; and
communicate the portfolio rate of return and the one or more account rates of return to a reporting system.

16. The medium of claim 15, wherein the defined period is one business day.

17. The medium of claim 16, wherein the one business day is a business day immediately preceding the calculating a rate of return for the account portfolio.

18. The medium of claim 15, the logic when executed further operable to:
receive transaction information associated with one or more transactions from a transaction information database, the one or more transactions representing asset activity associated with the one or more customer accounts; and
select from the one or more transactions one or more transactions that change a value of assets with the one or more customer accounts, wherein the determining one or more account rates of return comprises calculating the one or more account rates using the one or more transactions that change the value of assets within the one or more customer accounts.

19. The medium of claim 15, the logic when executed further operable to communicate the calculation of the one or more account rates of return to a quality control system, wherein the quality control system:
determines whether the one or more account rates of return comprise one or more errors;
flags each of the one or more account rates of return as having an error; and
communicates the one or more to a correction module, the correction module operable to issue corrections and request recalculation of the flagged one or more account rates.

20. The medium of claim 19, the quality control system further operable to combine the errors if the errors affect a predetermined number of customer accounts, the quality correction module being operable to correct the combined potential errors.
